(19) United States
(12) Patent Application Publication
(10) Pub. No.: US 2024/0000259 A1
(43) Pub. Date: Jan. 4, 2024

(54) SYSTEM FOR DISPENSING INDIVIDUAL PORTIONS OF BEVERAGES PRECURSOR

(71) Applicant: SOCIETE DES PRODUITS NESTLE S.A., Vevey (CH)

(72) Inventors: NICOLAS OBLIGER, Franey (FR); RUDOLF SCHENK, Konolfingen (CH)

(21) Appl. No.: 18/258,097

(22) PCT Filed: Dec. 6, 2021
(86) PCT No.: PCT/EP2021/084434

§ 371 Date: Jun. 16, 2023

(30) Foreign Application Priority Data
Dec. 21, 2020 (EP) 20215983.6

(51) Int. Cl. A47J 31/36; A47J 31/44

(52) U.S. Cl. CPC A47J 31/3647; A47J 31/4403

(57) ABSTRACT

The invention concerns a beverage portion dispenser (1) arranged for dispensing beverage precursor portions (3), said portions being individually contained in a flexible portioning band (2), said band being held in a casing (6), said dispenser comprising: —a receiving area (11) for receiving and holding the casing (6), —a band drive assembly (12) arranged for taking the band (2) out of the casing (6) and for moving successively each sealed beverage precursor portion to a separating assembly, —a separating assembly (13) configured to individually separate each portion (3) from the band (2), —a collecting chamber (15) configured to store the band separated from the portion, wherein said dispenser comprises: —a pushing member (16) configured to push the whole band (2) out of the collecting chamber (15) to the receiving area (11).

### FIELD OF THE INVENTION

The present invention relates to an apparatus for dispensing individual portions of beverage precursor stored as a packaging band and adapted to the preparation of beverages in a beverage preparation device.

### BACKGROUND OF THE INVENTION

Document WO2019/219523 discloses a beverage portion dispenser for receiving a portioning band containing a plurality of individually sealed beverage precursor portions for the preparation of a beverage wherein the dispenser comprises means for individually collecting and dispensing the beverage precursor portions to a dispensing area, wherein the collecting and dispensing means comprises a portion drive assembly arranged for receiving a part of the flexible portioning band and a separating assembly for individually separating the beverage precursor portions from the portioning band. The portioning band is initially arranged in a casing, and is progressively withdrawn from it.

With this dispenser, once the precursor portion has been separated from the band, the band separated from the portion is progressively collected in a waste container. When all the precursor portions have been separated and the whole used band is hold in the waste container, the casing is manually or automatically pushed inside the waste container and against the used band which is forced to enter the casing through an openable aperture on the lateral side of the casing, such as a weakening line.

This solution presents the disadvantage of designing an important volume of the beverage portion dispenser for the storage of the used band while limiting the volume of precursor portions that can be hold inside the dispenser. In fact, the waster container represents a large volume of the dispenser since it must be bigger than the casing to enable the latter to slide and enter inside the waste container. In addition the translation of the casing requires a deep dimension of the dispenser representing at least twice the length of the casing. As a result the dispenser is too voluminous.

### SUMMARY OF THE INVENTION

An object of the invention is to address the above existing problem.

In a first aspect of the invention, there is provided a beverage portion dispenser arranged for dispensing beverage precursor portions, said portions being individually contained in a flexible portioning band, said band being held in a casing, said dispenser comprising:
a receiving area for receiving and holding the casing,
a band drive assembly arranged for taking the band out of the casing and for moving successively each sealed beverage precursor portion to a separating assembly,
a separating assembly configured to individually separate each portion from the band,
a collecting chamber configured to store the band separated from the portion, wherein said dispenser comprises:
a pushing member configured to push the whole band out of the collecting chamber to the receiving chamber.

The beverage portion dispenser is arranged to dispense portions of beverage precursor. Each of said portions is contained in a flexible portioning band and the band itself is held in a casing. Accordingly, the beverage portion dispenser is arranged to hold the casing and to separate the beverage precursor portions from the band contained in the casing, usually by pulling the band out of the casing and then separating the portions from the band.

This dispenser comprises a receiving area for receiving and holding the casing during the dispensing operation. The receiving area defines and empty volume in which the casing is introduced and hold.

The dispenser comprises a band drive assembly arranged for taking the band out of the casing and for moving successively each sealed beverage precursor portion to a separating position.

The band drive assembly may comprise a driving member comprising portion receiving cavities shaped for individually catching a number of portions and for moving the respective part of the band containing the caught portions to the separating assembly. For example, the receiving cavity may have a circular opening which matches the cross-section of the beverage precursor portions which may be compacted and of substantially spherical shape. The number of portions that may be caught by the portion drive assembly to ensure a balance between a gentle but reliable drive of the system is preferably between 2 and 5, more preferably 3 or 4 beverage precursor portions.

In the preferred form, the drive member comprises at least one driving wheel with a cylindrical wall provided with portion receiving cavities spaced apart at its circumference and a motor for driving the cylindrical wall in rotation along an axis transversal to the driving direction of the portioning band. The driving member is arranged with control means to move the driving wheel incrementally or step-wisely of one step at a time to position one receiving cavity containing a beverage precursor portion next to the separating assembly.

The driving wheel preferably comprises positioning members arranged incrementally on the driving wheel to cooperate with at least one position sensor. Therefore, the driving wheel can be advanced from one increment at a time and this increment is determined by the position sensor. The position sensor can be mechanical, optical and or electromagnetic. The positioning members could also be omitted and the beverage precursor portions could be sensed by the position sensor instead. The driving wheel may be driven by a motor coupled to the driving wheel by a transmission system, for example a combination of a geared wheel and endless screw. The driving wheel can be dimensioned as a function of the arrangement of the portions in the portioning band and especially in relation to the distance between the centers of the neighboring portions, the diameter of the portions and the number of portions to be received by the cavities when the band is pulled by the portion drive assembly.

The dispenser comprises a separating assembly configured to individually separate each portion from the band.

The separating assembly may comprise a cutting tool for opening the portioning band at the location of each individual beverage precursor portion. The cutting tool comprises a cutter arranged for cutting at least one cutting line in the band preferably around the beverage precursor portion. In particular, the cutter may be arranged for cutting the band at a cutting line which is preferably located at the intersection between the beverage precursor portion and a sealed part of the band. The sealed part may be formed by the sealing of two packaging sheets. By cutting at the intersection, the cutter does not damage the portion as it might be brittle and would break easily into smaller pieces.

The separating assembly may comprise an extracting member arranged for engaging against the beverage precursor portion after the band has been cut by the cutting tool. The extracting member assists the removal of the beverage precursor portions by ensures that the portions are properly detached from the band as they may adhere by vacuum and/or mechanical or material sticking effect in the thermoformed receiving cavities.

The extracting member may be formed as a stationary protruding surface positioned angularly after the cutting tool and inside a driving wheel so that when the wheel is driven in rotation and a receiving cavity filled with a portion comes in radial alignment with the extracting member, the beverage precursor portion abuts against the protruding surface and is forced outside the cavity of the driving wheel.

Preferably, the dispenser comprises a dispensing chute to guide the separated portion of beverage precursor out of the dispenser, usually to a beverage preparation unit.

The apparatus may further comprise detecting and/or identifying member arranged for detecting and/or identifying at least one detection and/or identification element associated to the beverage precursor portion(s). For example, the detecting and/or identifying member is an optical reader and the detection and/or identification element is an optical element, such as a barcode, glyph or design, which is positioned on the portioning band. Preferably, an optical element is placed between two neighboring beverage precursor portions. The detection or identification element may provide information to the apparatus such as: the type of beverage precursor portions, the number of portions on the band, the counting of the beverage precursor portions on the band and any combinations thereof.

The dispenser comprises a collecting chamber configured to store the band separated from the portion and collect the whole separated band once all the portions are separated.

Preferably, the dispenser comprises a guiding means to guide the band separated from the portion to the collecting chamber. According to the preferred embodiment, the guiding means can comprise two rollers arranged to move the flexible band between their rotating surfaces. This embodiment presents the advantage of continuously maintaining and driving the band till it is stored in the downstream collecting chamber. The part of the band upstream the zone gripped by the rollers remain tight and cannot bend which could impact the correct movement and handling of the band upstream.

Preferably, the dispenser comprises a band compressing assembly arranged to compress the band separated from the portion before it is introduced inside the collecting chamber.

As a result, the volume of the band is reduced and the internal volume of the collecting chamber can be reduced too, particularly when the band comprises cavities to hold the individual precursor portions, which cavities are a little bid rigid and retain their form after the portions were extracted.

In the preferred embodiment, the compressing assembly and the guiding means are combined. In particular these devices consist in two rollers arranged to move and compress the flexible band between their rotating surfaces.

In addition, the dispenser comprises a pushing member configured to push the whole band out of the collecting chamber. Once the band is fully collected in the collecting chamber and not more engaged in the driving assembly, in the separating assembly or in the compressing assembly, the pushing member can freely evacuate the band from the collecting chamber. The pushing member configured to push the whole band to the receiving area.

Consequently, the pushing member can push the whole band inside any container present in the receiving area, in particular the casing that does not comprise the band any longer at this step of the process since the whole band is present in the collecting chamber.

In one preferred embodiment, the receiving area is positioned below the collecting chamber. Consequently, the evacuation of the compressed flexible band by the pushing member is facilitated due to gravity fall.

In this embodiment, preferably, the collecting chamber is devoid of bottom wall. As a result the bottom of the collecting chamber is opened above the receiving area and the movement of the pushed flexible band is facilitated. In addition, as the casing is present inside the receiving area, the top wall of the casing extends along the bottom of the collecting chamber and defines a bottom wall during the collection of the flexible band in said collecting chamber.

Preferably the pushing member is designed to slide along the lateral sides of the collecting chamber so as to gather the whole band.

In a second aspect, there is provided a casing holding a flexible portioning band, said band containing a plurality of individually sealed beverage precursor portions and said casing comprising a top wall, said top wall comprising a front part and a rear part, wherein:
the top wall comprises an aperture, said aperture being positioned in the front part of the top wall, and
the rear part of the top wall is configured to be openable under the application of an inwardly oriented force.

The casing holds a flexible portioning band, which contains a plurality of individually sealed beverage precursor portions, and that can cooperate with a beverage portion dispenser such as described above. The beverage precursor enables the preparation of a beverage in a beverage preparation device further to mixing with a liquid.

The casing is self-standing, preferably rigid or semi-rigid protective casing. It provides a compact storage without the portioning band being directly manipulated so reducing the risk of damaging the beverage precursor portions. The casing can be made of compostable material, in particular one or a combination of cardboard, paper, cellulose, cellophane, PLA. The portioning band comprising a pair of packaging sheets sealed to one another for enclosing and sealing the portions individually and separately in a substantially oxygen impervious manner by the sheets being sealed together about each portion and forming cavities. Preferably, the beverage precursor portions take the form of substantially spherical shapes which are covered on each side of the portioning band by a sheet being formed with cavities to receive each portion and wherein at least one of the sheets can be cut or torn at least partially about each portion for removal of each portion individually.

Preferably, the band comprises a free part of the sheets between the neighboring beverage precursor portions such that the band can be arranged in continuous manner in superimposed or wound layers with the portions being arranged in quincunx between two adjacent layers.

The portioning band may preferably be arranged in a continuous manner in superimposed layers within the casing.

Preferably, the portioning can be identical to the band described in WO 2019/219524.

The top wall casing extends in one direction between a front end and a rear end. Usually lateral walls extend from the edges of the top wall to a bottom wall. Preferably, the casing presents the shape of a parallepiped.

The top wall comprises an aperture that is positioned in the front part of the top wall.

The first end of the flexible portioning band can be pulled out from said aperture. Accordingly, inside the casing this first end of the flexible portioning band is preferably positioned close to said aperture.

In addition, the rear part of the top wall is configured to be openable under the application of an inwardly oriented force.

When this casing with this particular top wall of the casing is introduced inside a beverage portion dispenser such as described above, the flexible band can be pulled out from the opening in the front part of the top wall, and the flexible band can be repacked inside the casing through the rear part of the top wall since the latter is openable under the application of an inwardly oriented force, such as the force exerted by the pushing member.

The rear part of the top wall can comprise any means that makes it openable under the application of an inwardly oriented force.

The rear part of the top wall can be made of a material that is more fragile than the rest of the casing and that breaks under the application of an inwardly oriented force and/or the rear part of the top wall can be weakened by the removal or the piercing of the material the top wall is made of.

In one preferred embodiment the rear part can comprise one slit centered laterally in the top wall and extending between the rear and front directions. This slit defines two lateral flaps that can be pushed aside by the pushing member or by the flexible band pushed by the pushing member inside the empty casing.

Preferably, such a slit and the aperture at the front part can be made of the same cut out in the top wall.

Preferably, the casing comprises a removable cover, said cover closing at least the aperture in the front part of the top wall.

This cover is present before the casing is used within the dispenser and can be removed manually or automatically inside the dispenser when the casing is introduced inside the dispenser.

If the rear part of the top wall is pieced or weakened by the removal or the piercing of the material the top wall is made of, then preferably this cover closes the rear part too. Alternatively, another cover can be provided for the rear part.

According to a third aspect, there is provided a system of a beverage portion dispenser such as described above and a casing such as described above, wherein, when the casing is held inside the receiving area of the beverage portion dispenser, the rear part of the top wall of the casing is positioned below the collecting chamber.

Consequently, once the casing is held in the receiving area and, during all the time of the operation of dispensing the precursor portions from the band contained in the casing, the rear part of the top wall is positioned at the bottom of the collecting chamber and is ready to recover the empty flexible band. No movement of the casing in different positions is necessary.

The receiving area defines and empty volume in which the casing is introduced and hold. This empty volume corresponds to the external volume of the casing.

Accordingly, the volume of the dispenser is reduced to the minimal volume.

In one preferred embodiment, the collecting chamber is devoid of bottom wall and the rear part of the top wall forms the bottom of the collecting chamber.

Consequently, the rear part of the top wall, that is openable under the application of an inwardly oriented force, remains close as long as the empty flexible band is progressively collected inside the collecting chamber and rests on the surface of the rear part of the top wall. Consequently, the rear part of the top wall separates the first end of the empty flexible band stored in the collecting chamber from the second end of flexible band still containing the precursor portions and still contained in the casing.

It is only when the pushing member exerts a force on the band and inwardly on the rear part of the top wall that said rear part opens to receive the full empty band.

Preferably, in said preferred embodiment, the rear part of the top wall of the casing is configured to provide a resistance sufficient to support the weight of the band stored in the collecting chamber but not sufficient to resist the pressure of the pushing member when said pushing member pushes the whole band out of the collecting chamber.

Although the rear part of the top wall is openable under the application of an inwardly oriented force, this rear part does not open under the force exerted by the weight of the flexible band hold inside the casing. In particular, when the rear part of the top wall is used to form the bottom wall of the collecting chamber, the weight of the compressed flexible band is not strong enough to open the rear part.

Preferably, the receiving chamber comprises means to cooperate with the external shape of the casing and configured to guide the introduction of the casing so that the rear part of the top wall of the casing is positioned under the collecting chamber.

These means can be cooperating shapes such as poka-yoke members provided on the external surfaces of the receiving area and of the casing.

In one preferred embodiment, the edge of the rear end of the top wall of the casing comprises a flange extending longitudinally and transversely from the top wall whereas the front end of the top wall does not comprise such a flange. The lateral walls of the receiving area comprises grooves configured to cooperate with said flange of the rear part.

In a fourth aspect, there is provided the use of a casing such as described in the above second aspect in a beverage portion dispenser such a described in the above first aspect.

In a fifth aspect, there is described a food or beverage dispenser comprising a beverage portion dispenser such as described above.

Preferably, the beverage portion dispenser comprises a dispensing chute to guide the portion out of the beverage portion dispenser to a beverage preparation unit.

In the present application the terms “internal”, “external”, “rear”, “front”, “top”, “bottom” and “lateral” are used to describe the relational positioning of features of the invention. These terms should be understood to refer to the casing and the receiving area in their normal orientation when positioned in a beverage preparation dispenser for the production of a beverage as shown in FIGS. 1 to 4.

The above aspects of the invention may be combined in any suitable combination. Moreover, various features herein may be combined with one or more of the above aspects to provide combinations other than those specifically illustrated and described. Further objects and advantageous features of the invention will be apparent from the claims, from the detailed description, and annexed drawings.

### BRIEF DESCRIPTION OF THE DRAWINGS

Specific embodiments of the invention are now described further, by way of example, with reference to the following drawings in which:

FIG. 1 illustrates a beverage dispenser 100 comprising a system according to the invention,

FIG. 2A is a perspective view of the casing during its use and FIG. 2B is a perspective view of the casing before its use,

FIG. 3 is a vertical cross section of the casing of FIG. 2,

FIG. 4 is a vertical cross section of the system of the beverage portion dispenser and the casing,

FIGS. 5A and 5B are isolated views of parts of the dispenser according to the invention,

FIG. 5C is an isolated view of the compressing member,

FIGS. 6A and 6B are isolated views of parts of the dispenser.

### DETAILED DESCRIPTION OF EXEMPLARY EMBODIMENTS

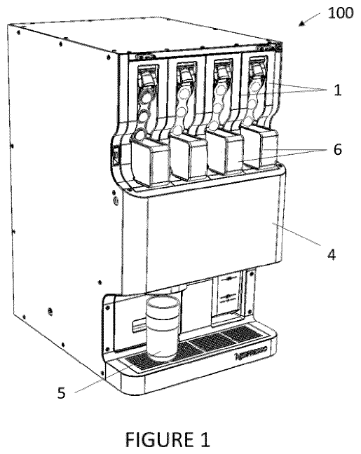

FIG. 1 illustrates a beverage dispenser 100 enabling the dispensing of a beverage in a drinking cup 5. The beverage dispenser comprises a beverage preparation unit 4 configured to prepare a beverage from a beverage precursor portion.

The beverage dispenser comprises several beverage precursor portion dispensers 1, each of them being configured to dispense a beverage precursor portion from a casing 6 holding said beverage precursor portions.

The different beverage precursor portion dispensers 1 can hold different types of precursors, like infusible precursor like roast and ground coffee or different types of roast and ground coffee differing by their origins or treatments (decaffeinated), or soluble precursor like soluble coffee, milk powder, chocolate powder. Some or all of the dispensers 1 can also dispense the same precursors.

The beverage preparation unit 4 comprises at least one device for contacting the beverage precursor portion with a diluent. Different types of devices can be implemented alone or in combination such as: a jet(s) head, a mixing bowl, a whipper bowl, a brewing chamber.

The mixing bowl can be a chamber configured to receive the diluent and at least one soluble beverage precursor. It can be designed so as to make an efficient contact of the precursor and the diluent and improve the dissolution of the soluble precursor.

The jet(s) head can be a nozzle delivering at least one jet of diluent in the mixing bowl.

The whipper bowl usually comprises a first part which is a mixing chamber configured to receive the diluent and the soluble precursor and a second part comprising a whipper configured to make the mixture of the diluent and the precursor foam.

The brewing chamber can be a chamber configured to receive an infusable beverage precursor and water. In the brewing process, heated water infuses and extracts flavours from the infusable precursor. The brewing chamber can contain a filter to allow beverage to drain from the infused precursor and water mixture It can be configured to be hermetically closed to receive and hold the diluent under pressure and to retain the infusable precursor.

The beverage preparation unit 4 can comprise several devices for contacting the beverage precursor portion with a diluent, these several devices can be either identical or different. In another embodiment, the dispenser 1 can be a food dispenser comprising a food beverage preparation unit in place the beverage preparation unit 4.

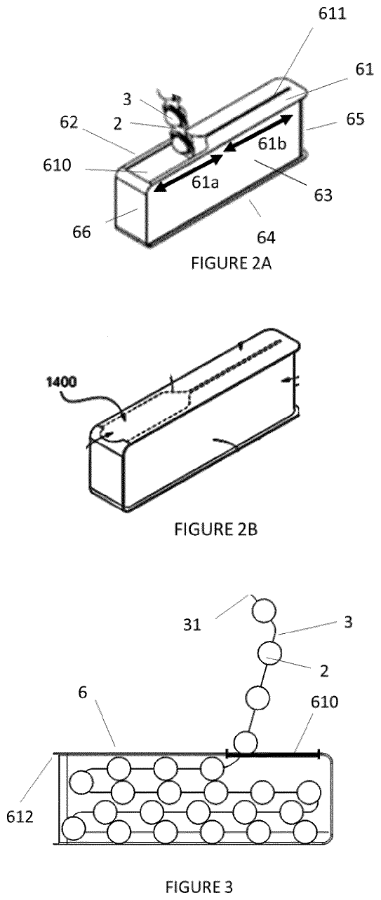

As illustrated in FIGS. 2A, 2B and 3, the casing 6 holds a flexible portioning band 3 containing a plurality of individually sealed beverage precursor portions 2, such as the band described in WO 2019/219523 and WO 2019/219524. The casing 6 comprises a top opening 610 from which the band can be pulled out and driven by a driving wheel of the beverage precursor portion dispenser as explained below.

In the illustrated preferred embodiment, the casing 6 present a parallepipedic shape with a top wall 61 extending longitudinally between a rear end close to the rear wall 65 and a front end close to the front wall 66. The top wall 61 comprises an aperture 610 that is positioned in the front part 61a of the top wall. The flexible band 3 is positioned inside the casing in order to be pulled out form this aperture 610, the first end 31 of the flexible band being positioned close to this aperture in order to be directly accessible and pulled out by the dispenser 1. The rear part 61b of the top wall comprises a thin slit 611. The aperture 610 and the slit 611 are made of the same cut out of the top wall. FIG. 2B shows the presence of tearable cover 613 protecting the aperture ne the slit before the use of the casing.

In another embodiment the slit in the rear part can be replaced by a tearing line.

The material the casing is made of can be:
a paper-based structure material such as PBS, PLA, cellulose and combinations thereof.
a laminated paper. The laminate may comprise a seal layer such as PLA, PBA, PBS, copolyester of adipidic acid, 1, 4-butanediol and dimethyl terephthalate (PBAT), polylactic acid (PLA), polyvinyl butyral (PVB), poly(vinyl acetate-ethylene) (VAE), poly(ethylene-vinyl acetate) (EVA) and combinations thereof. It may comprise an oxygen barrier layer such as EVOH, PVOH, SiOx, cellophane, metal and combinations thereof. An example of laminate can be PLA/EVOH/PLA. In these examples, PLA may be replaced by PBA, PBS, PPS, copolyester of adipidic acid, 1, 4-butanediol and dimethyl terephthalate (PBAT), polyvinyl butyral (PVB), poly(vinyl acetate-ethylene) (VAE), poly(ethylene-vinyl acetate) (EVA) and combinations thereof. EVOH may also be replaced by PVOH and/or SiOx.
at least one part of the blank is made of a rigid and/or semi-rigid materials: it could for instance be a fiber based material (solidboard).

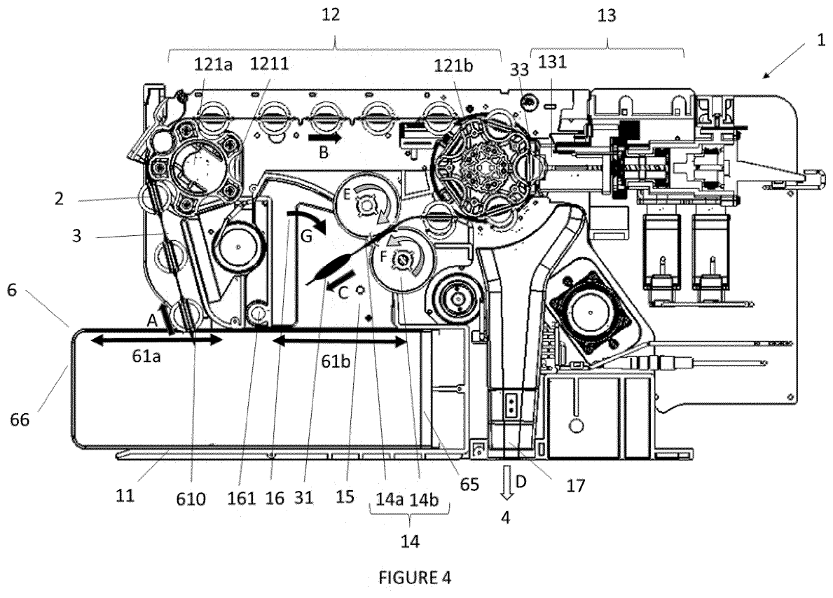

FIG. 4 illustrates the casing positioned inside the dispenser 1 in a status of dispensing operation.

The casing 6 has been received and is hold inside the receiving area 11 of the dispenser. The casing 6 has been oriented inside the receiving area with the rear wall 65 and rear part 61b of the top wall at the rear inside of the receiving area whereas the front wall and the front part 61a of the top wall remains partly outside the receiving area 11. This orientation of the casing can be facilitated by cooperating shapes of the casing 6 and of the receiving area 11 such as the flange 612 between the rear wall and the top wall if the casing fitting inside the groove 111 on the lateral side of the receiving area.

The dispenser 1 comprises a band drive assembly 12, a separating assembly 13, a collecting chamber 15, a guiding and compressing assembly 14 and a pushing member 16.

The band drive assembly 12 is arranged to pull the band 2 out of the casing and to supply it to the separating assembly 13. The band drive assembly 12 comprises a first driving wheel 121a arranged for taking the band 2 out of the casing 6 and a second driving wheel 121b for positioning the band in the separating position, both wheels moving successively each sealed beverage precursor portion from the casing to the separating assembly 13 and then to the collecting chamber 15. The arrows A, B, C illustrate the movement of the band 2 in the dispenser.

Each driving wheel or drum 121a, 121b is provided with a plurality of portion receiving cavities 1211 arranged in circumferential alignment formed in the outer annular surface of the driving wheel or drum. The wheels are driven in rotation in a stepwise fashion by corresponding driving members. Each wheel is mounted around an axle of transversal axis. The receiving cavities 1211 are individually dimensioned and arranged at distance one another so as to match with the distance between the neighboring beverage portions of the band. As the portions are captured by the receiving cavities 1211 moving step-wisely, the portioning band 3 is progressively withdrawn from the casing 6 and moved to the separating assembly 13 and then to the collecting chamber 15.

The separating assembly 13 is configured to individually separate each beverage precursor portion 2 from the band 3.

The separating assembly essentially comprises a cutting tool 131 The cutting tool is arranged for at least partially cutting an opening in the band 3 about the forefront sealed portion 3a present in the portion drive assembly.

An extracting member can be provided to assist the removal of the portion from the receiving cavity after the cutting operation took place. Such member may be a pushing member or other equivalent means such as a vacuum extraction means that pulls the portion from the receiving cavity rather than push it outside. The extracting member may also be optional.

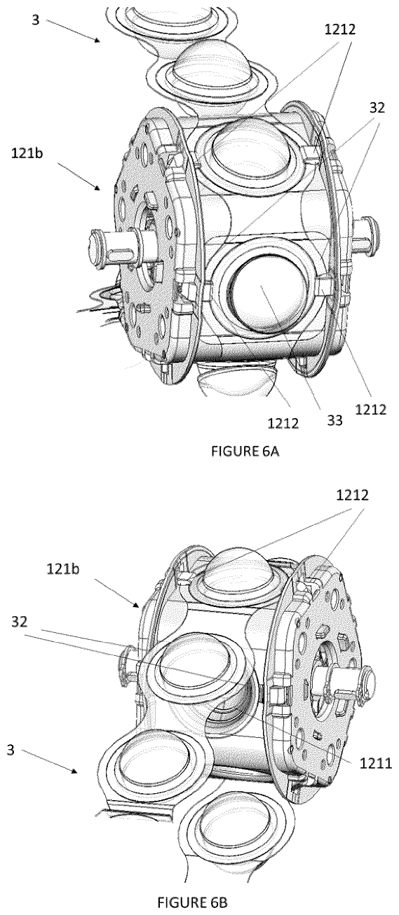

FIGS. 6A and 6B are perspective views illustrating two sides of the driving wheel 121b that supports and moves the band 3 and that simultaneously receives the portions in cavities 1211. In order to firmly hold the band 3 and the portion 2 inside the cavities, the band drive assembly comprises pairs of retaining arms 1212 on the lateral side of each cavities. These retaining arms are designed to stick the band 3 to the surface of the driving wheel 121b, in particular by gripping the lateral edges 32 of the band positioned on the lateral sides of the cavities. In FIG. 6A, the part 33 of the band is hold in a cavity that is positioned at the separation position of the dispenser meaning in the position facing the cutting tool 131 in order to be cut (as illustrated in FIG. 4). During the operation of cutting, the band 3 may be torn and the retaining arms prevent the band 3 from leaving the path defined by the wheel or from rotating under the effect of the cutting tool, as a result cutting is facilitated too.

The dispenser comprises a portion collecting means 17, such as a chute and the like, arranged for gently receiving and transporting by gravity or otherwise (e.g. air pressure), the beverage portion 2 to a beverage preparation unit 4 as illustrated by the downwardly oriented arrow D.

The band guiding assembly 14 is arranged to guide the band separated from the portion 2 and then to introduce said band 31 inside the collecting chamber 15.

In the illustrated embodiment, the band guiding assembly comprises two rollers 14a, 14b rotating in opposite directions, the roller 14 a rotating clockwise whereas the roller 14b rotates counterclockwise. The second driving wheel 121b is arranged to drive and introduce the first end of the band 2 between the surfaces of the two rollers with the result that:
first, the band is pulled by the two rollers and introduce in the downstream collecting chamber 15, and
secondly the parts of the band that were designed to contain the beverage precursor portions and that presented a certain volume are simultaneously compressed between the surface of the rollers which has the effect of reducing the volume of the band introduced inside the collecting chamber 15.

The surfaces of the two rollers can present a surface designed to firmly hold the band and avoid the band to slide, for example at least a part of these surfaces can be covered with a rubber material.

The two rollers present the advantages of close the inlet of the collecting chamber for the flexible band and prevents the band from bending and extending out of the collecting chamber which may jam the dispenser.

The band compressing assembly can alternatively comprise any other means enabling the compression of the empty parts of the band like a piston squeezing said parts at a compressing position of the band downstream the separating position and upstream the collecting chamber according to the direction of the band.

The collecting chamber 15 is configured to store the band from which the beverage precursor portions are separated and that is compressed.

This collecting chamber is devoid of bottom wall. The bottom of this chamber opens in the receiving area 11 and, when the casing 6 is in the receiving area which is mandatory when a band is being pulled out of the casing and processed in the dispenser, then the rear part 61b of the top wall of the casing forms the bottom of the collecting chamber and consequently supports the band 2 as long as the operation of collection of this band happens. As more and more beverage precursor portions are dispensed and the band 2 is driven and compressed and collected, the collecting chamber 15 becomes more and more full, yet the rear part 61b of the top wall remains sufficiently strong to support the weight of the band.

The pushing member 16 is configured to push the band 2 out of the collecting chamber 15 when all the precursor portions have been separated from the band and the whole band has been compressed and driven inside the collecting chamber 15.

The pushing member 16 is configured to move and designed to collect the whole band during its movement in direction of the receiving area as illustrated by the arrow G. The pushing member 16 is particularly designed so that its movement enables the opening of the rear part 61b of the top wall of the casing which facilitates the introduction of the band 2 inside the casing 6.

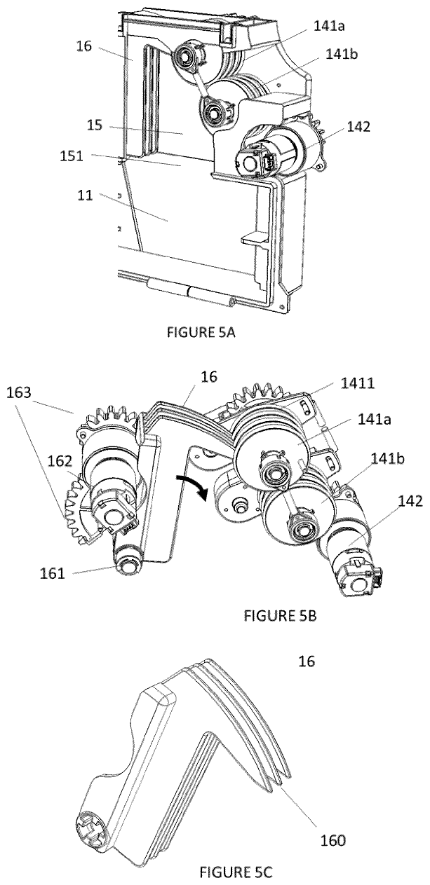

FIG. 5A is an isolated perspective view of the collecting chamber 15 and the receiving area 11 of the dispenser of FIG. 4, the casing being removed therefrom. Due to the absence of wall at the bottom 151 of the collecting chamber, when the pushing member 16 is moved according to the direction of the arrow G, the first free end 160 of the pushing member is able to pass through said bottom and enter the receiving area 11 where the casing is hold. As illustrated in FIG. 5C, the pushing member is a lever configured to rotate around a horizontal axis 161 cooperating with its second fixed end. A motor 162 and cooperating gears 163 enable the rotation of the lever.

The free end 160 of the lever comprises three teeth and the surfaces of the rollers 141a, 141b comprise three grooves arranged to enable the passage of the three teeth during the movement of the pushing member. As a result, the free end of the lever is able to swipe the whole volume of the collecting chamber including the tiny space between the rollers. If a part of the band is placed in this space, it is collected by the lever during its rotating movement. In addition the teeth can easily tear the rear part end 61b of the front wall of the casing when they reach the bottom 151 of the collecting chamber. If this rear part end 61b is provides with a central slit 611 as illustrated in FIG. 2, the two lateral teeth put the lateral sides of the slit aside which opens a large aperture at the slit position and the central teeth pushes the band through said large aperture. The band is totally repacked inside the casing 6.

Preferably the rear part 61b of the casing is made of a material that does not bend completely under the pressure of the lateral teeth and that can recover its original shape when the pushing member is removed.

Although the invention has been described with reference to the above illustrated embodiments, it will be appreciated that the invention as claimed is not limited in any way by these illustrated embodiments.

Variations and modifications may be made without departing from the scope of the invention as defined in the claims. Furthermore, where known equivalents exist to specific features, such equivalents are incorporated as if specifically referred in this specification.

As used in this specification, the words “comprises”, “comprising”, and similar words, are not to be interpreted in an exclusive or exhaustive sense. In other words, they are intended to mean “including, but not limited to”.

### LIST OF REFERENCES IN THE DRAWINGS

beverage precursor portion dispenser 1
receiving area 11
groove 111
band drive assembly 12
driving wheel 121a, 121b
cavity 1211
retaining arms 1212
separating assembly 13
cutter 131
positioning wheel 132
guiding and compressing assembly 14
roller 141a, 141b
groove 1411
motor 142
collecting chamber 15
bottom 151
pushing member 16
free end 160
axis 161
motor 162
dispensing chute 17
beverage precursor portions 2
flexible portioning band 3
compressed band 31
lateral edge 32
band in cutting position 33
beverage preparation unit 4
cup 5
casing 6
top wall 61
aperture 610
slit 611
flange 612
cover 613
lateral walls 62, 63
bottom wall 64
rear wall 65
front wall 66
beverage dispenser 100

1. Beverage portion dispenser arranged for dispensing beverage precursor portions, said portions being individually contained in a flexible portioning band, said band being held in a casing, said dispenser comprising:
a receiving area for receiving and holding the casing,
a band drive assembly arranged for taking the band out of the casing and for moving successively each sealed beverage precursor portion to a separating assembly,
a separating assembly configured to individually separate each portion from the band,
a collecting chamber configured to store the band separated from the portion, and
a pushing member configured to push the whole band out of the collecting chamber to the receiving area.

2. Beverage portion dispenser according to claim 1, wherein said dispenser comprises a guiding member to guide the band separated from the portion to the collecting chamber.

3. Beverage portion dispenser according to claim 1, wherein the guiding member comprises two rollers arranged to move the flexible band between their rotating surfaces.

4. Beverage portion dispenser according to claim 1, wherein the pushing member is configured to push the whole band to the receiving area.

5. Beverage portion dispenser according to claim 1, wherein the receiving area is positioned below the collecting chamber.

6. Beverage portion dispenser according to claim 1, wherein the collecting chamber is devoid of bottom wall.

7. Casing holding a flexible portioning band, said band containing a plurality of individually sealed beverage precursor portions and said casing comprising a top wall, said top wall comprising a front part and a rear part, wherein:
said top wall comprises an aperture, said aperture being positioned in the front part of the top wall, and
the rear part of the top wall is configured to be openable under the application of an inwardly oriented force.

8. Casing according to claim 7, wherein the rear part is made of a material that is more fragile than the rest of the casing and/or a part of the rear part is weakened by the removal or the piercing of the material the top wall is made of.

9. Casing according to claim 8, wherein the rear part of the top wall comprises at least one slit extending longitudinally between the rear and the front directions, preferably one slit centered laterally in the top wall and extending between the rear and front directions.

10. Casing according to claim 9, wherein the slit and the aperture are made of the same cut out.

11. System of a beverage portion dispenser arranged for dispensing beverage precursor portions, said portions being individually contained in a flexible portioning band, said band being held in a casing, said dispenser comprising:
a receiving area for receiving and holding the casing,
a band drive assembly arranged for taking the band out of the casing and for moving successively each sealed beverage precursor portion to a separating assembly,
a separating assembly configured to individually separate each portion from the band,
a collecting chamber configured to store the band separated from the portion, and
a pushing member configured to push the whole band out of the collecting chamber to the receiving area and a casing holding a flexible portioning band, said band containing a plurality of individually sealed beverage precursor portions and said casing comprising a top wall, said top wall comprising a front part and a rear part, wherein:
said top wall comprises an aperture, said aperture being positioned in the front part of the top wall, and
the rear part of the top wall is configured to be openable under the application of an inwardly oriented force, wherein when the casing is held inside the receiving area, the rear part of the top wall is positioned below the collecting chamber.

12. System according to claim 11, wherein the collecting chamber is devoid of bottom wall and the rear part of the top wall forms the bottom of the collecting chamber.

13. System according to claim 12, wherein the rear part of the top wall of the casing is configured to provide a resistance sufficient to support the weight of the band stored in the collecting chamber but not sufficient to resist the pressure of the pushing member when said pushing member pushes the whole band out of the collecting chamber.

14. System according to claim 11, wherein the receiving chamber comprises means to cooperate with the external shape of the casing and guide the introduction of the casing so that the rear part of the top wall of the casing is positioned under the collecting chamber.

15-17. (canceled)
